(19) United States
(12) Patent Application Publication
(10) Pub. No.: US 2012/0268580 A1
(43) Pub. Date: Oct. 25, 2012

(54) PORTABLE COMPUTING DEVICE WITH INTELLIGENT ROBOTIC FUNCTIONS AND METHOD FOR OPERATING THE SAME

(76) Inventors: Hyun KIM, Daejeon (KR); Hyoung Sun Kim, Daejeon (KR); Nam Shik Park, Daejeon (KR); In Cheol Jeong, Daejeon (KR); Young Ho Suh, Gwangju (KR); Joo Haeng Lee, Daejeon (KR); Joon Myun Cho, Daejeon (KR); Myung Eun Kim, Daejeon (KR); Moo Hun Lee, Daejeon (KR); Kun Ouk Kim, Daejeon (KR); Jeong Nam Yeom, Jeollanam-do (KR); Blagovest Vladimirov, Gyeongsangnam-do (KR)

(21) Appl. No.: 13/444,030

(22) Filed: Apr. 11, 2012

(30) Foreign Application Priority Data
Apr. 12, 2011 (KR) 10-2011-0033700

(51) Int. Cl. H04N 7/18; H04R 3/00

(52) U.S. Cl. 348/77; 348/61; 381/122; 348/E07.085

(57) ABSTRACT

Disclosed is a portable computing device with intelligent robotic functions, including: an input projector providing a user interface screen for user input and mounted with a camera for capturing and recognizing a user behavior on the user interface screen; a main board recognizing a user command according to the user behavior and generating service and contents according to the user command; and an output projector outputting the generated contents.

### CROSS-REFERENCE TO RELATED APPLICATIONS

This application claims priority to and the benefit of Korean Patent Application No. 10-2011-0033700 filed in the Korean Intellectual Property Office on APRIL 12, 2011, the entire contents of which are incorporated herein by reference.

### TECHNICAL FIELD

The present invention relates to a portable computing device with intelligent robotic functions and a method for operating the same, and more particularly, to a portable computing device with intelligent robotic functions that provides more improved user input and output and intelligent functions by providing input and output devices such as a projector, a camera, a microphone, and a touch sensor and multimodal interaction based on a user's voice, gesture, and touch and a method for operating the same.

### BACKGROUND ART

In recent years, with trends toward convergence and integration, personalization, and high intelligence of a network, a computer, communication, and a home appliance, different types of new computing devices from existing personal computers (PCs) are appearing in a living environment.

In general, a computer is configured by a keyboard, a mouse, and a screen to perform a function of computing a command according to input, but in recent years, user-centric computer products, which are combined with various interfaces inputting and displaying user commands such as a touch panel, a camera, and a project screen, are rapidly appearing.

Apple released a portable multimedia terminal in which a multi-touch screen is used for a tablet computer type 9.7-inch IPS panel and Microsoft released a computer that uses concepts of a surface computing projection and a table top that can directly manipulate digital information with hands.

Microsoft has recently developed an interface device that recognizes user commands by recognizing user's movement, gesture, and voice using a camera and a sensor device.

MIT Media Lab has developed Sixth Sense and LuminAr using a screen and a camera as a projector.

### SUMMARY OF THE INVENTION

The present invention has been made in an effort to provide a new type of computing device having advanced functions and functions of an intelligent personal service robot by including various sensors and devices, in order to provide (1) input and output interaction using cameras and projectors, (2) a user perception function using multimodal sensors such as an image, a voice, and a touch, (3) context-awareness of a user and an environment, and (4) an autonomous and evolutionary behavior function through the long-term relationship with the user.

The present invention also has been made in an effort to provide a new type of computing device having functions of an intelligent personal service robot by including various sensors and devices, in order to provide more natural user interfaces by providing input and output devices based on projectors, cameras, a multi-channel microphone, and a touch sensor and multimodal interaction based on a user's voice, gesture, and touch.

The present invention also has been made in an effort to recognize a user's location and recognize and track a user's face, detect the location of a surrounding sound and respond to a user's voice.

The present invention also has been made in an effort to detect available devices at a user's location and dynamically connect the devices through a network.

The present invention also has been made in an effort to provide more proactive services to a user by constructing information on who, when, where, and what task he or she performed and learning a user's device usage pattern.

An exemplary embodiment of the present invention provides a portable computing device with intelligent robotic functions, including: an input projector providing user interface screens for user input and mounted with a camera for capturing and recognizing a user behavior on the user interface screen; a main board recognizing a user's voice and gesture command according to the user behavior and controlling to generate service and contents according to the user command; and an output projector outputting the generated contents.

The output projector may be mounted with a camera for recognizing and tracking the user behavior.

The main board may recognize a user command according to a finger gesture on the user interface screen and control to generate the contents according to the user command.

The main board may receive image information from the camera and provides functions for ambient motion detection, face detection, face recognition, finger tip detection, finger gesture recognition and object detection and recognition.

The portable computing device with intelligent robotic functions may further include a multi-channel microphone receiving a user's voice, in which the main board may control to recognize user information and a user command according to the user's voice.

The main board may transmit sensor information receiving the user command to a server connected through a network, perform a recognition processing from the server, and receive service and contents according to the result.

The portable computing device with intelligent robotic functions may further include vertical motion motors provided at lower ends of the projectors and the cameras to vertically rotate; horizontal motion motors provided at lower ends of the vertical motion motors to horizontally rotate the projectors and the cameras; and an entire rotary motor provided at lower ends of the horizontal motion motors to rotate the projectors and the cameras in their entirety.

The cameras may be mounted at lower ends of the projectors, respectively.

The portable computing device with intelligent robotic functions may further include a knowledge base storing basic information on a user, geometric information and semantic information on a space, device and object information in an environment, and agent state-related information based on ontology, in which the main board controls to provide the information at the query request.

The main board may learn a behavior pattern in which a user uses a robotic computer and estimates a present state of the user to actively recommend related services and contents in accordance with the present state.

Another exemplary embodiment of the present invention provides a method for operating a portable computing device with intelligent robotic functions, including: providing a user interface screen and a screen for outputting services and contents; recognizing a user command according to a user behavior on the user interface screen; and outputting service and contents according to the user command.

The method may further include tracking the user behavior.

The method may further include detecting a movement state of the user; and correcting a position according to the movement of the user.

The method may further include receiving image information from the camera to provide functions for ambient motion detection, face detection, face recognition, finger tip detection, finger gesture recognition and object detection and recognition.

The method may further include receiving the user's voice sound from the multi-channel microphone to detect the location of the sound source and recognize a voice command.

The method may further include transmitting sensor information receiving the user command to a server connected through a network, performing a recognition processing from the server, and receiving the service and contents according to the result.

The method may further include storing basic information on the user, geometric information and semantic information on a space, device and object information in an environment, and agent state-related information based on ontology and rules; and providing the information at the query request.

The method may further include learning a behavior pattern in which a user uses a robotic computer and estimating a present state of the user to actively provide related applications and services in accordance with the present state.

The present invention provides the following effects.

First, the portable computing device with intelligent robotic functions interacts with a surrounding environment, and particularly, finds a person, recognizes who a user is, tracks the user, and performs an interaction function, if necessary, to perform user commands.

Second, the portable computing device with intelligent robotic functions provides a computing environment anytime and anywhere. In other words, the portable computing device with intelligent robotic functions can provide a table top type input and output environment at any place such as a living room, a kitchen, and a desk by using projectors, and a user can interact with a the robotic computer by using a finger gesture, a voice, or a touch.

Third, the portable computing device with intelligent robotic functions understands the current context on a user and a physical environment and provides a service in accordance with the current context in addition to a user's explicit request.

Fourth, the portable computing device with intelligent robotic functions serves to connect a physical world and a virtual world. In other words, it is possible to augment digital information on a physical object by recognizing an actual object through a camera, obtaining information on the object from a virtual space, and projecting the information using a projector.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating a robotic computer according to an exemplary embodiment of the present invention.

FIG. 2 is a diagram illustrating a portable computing device with intelligent robotic functions according to an exemplary embodiment of the present invention.

FIG. 3 is a block diagram illustrating a portable computing device with intelligent robotic functions according to an exemplary embodiment of the present invention.

FIG. 4 is a diagram illustrating a software configuration of a portable computing device with intelligent robotic functions according to an exemplary embodiment of the present invention.

FIG. 5 is a flowchart illustrating a control mechanism of a portable computing device with intelligent robotic functions according to an exemplary embodiment of the present invention.

FIG. 6 is a processing flowchart of a portable computing device with intelligent robotic functions according to an exemplary embodiment of the present invention.

FIG. 7 is a processing flowchart for position correction of a portable computing device with intelligent robotic functions according to an exemplary embodiment of the present invention in accordance with a user's movement.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

In exemplary embodiments described below, components and features of the present invention are combined with each other in a predetermined pattern. Each component or feature may be considered to be optional unless stated otherwise. Each component or feature may not be combined with other components or features. Further, some components and/or features are combined with each other to configure the exemplary embodiments of the present invention. The order of operations described in the exemplary embodiments of the present invention may be modified. Some components or features of any exemplary embodiment may be included in other exemplary embodiments or substituted with corresponding components or features of other exemplary embodiments.

The exemplary embodiments of the present invention may be implemented through various means. For example, the exemplary embodiments of the present invention may be implemented by hardware, firmware, software, or combinations thereof.

In the case of implementation by hardware, a method according to the exemplary embodiment of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

In the case of implementation by firmware or software, the method according to the exemplary embodiments of the present invention may be implemented in the form of a module, a process, or a function of performing the functions or operations described above. Software codes may be stored in a memory unit and driven by a processor. The memory unit is positioned inside or outside the processor to transmit and receive data to and from the processor by a previously known various means.

Predetermined terms used in the following description are provided to help understanding the present invention and the use of the predetermined terms may be modified into different forms without departing from the spirit of the present invention.

Hereafter, exemplary embodiments of the present invention will be described in detail with reference to the accompanying drawings.

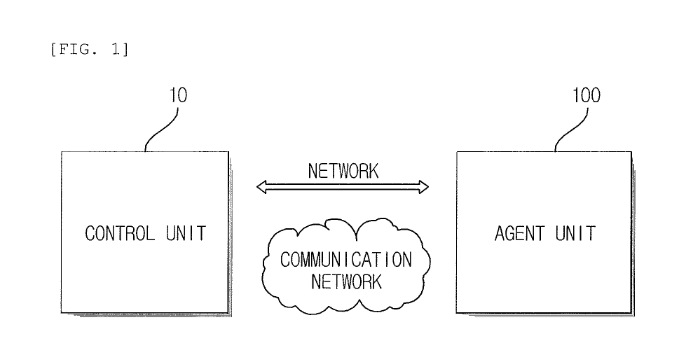

FIG. 1 is a block diagram illustrating a robotic computer according to an exemplary embodiment of the present invention.

Hereafter, a description is started with reference to FIG. 1.

A robotic computer proposed in the present invention consists of a control unit 10 and an agent unit 100.

The control unit 10 is a central processing unit and serves as a brain server of the agent unit. Considering that our future living environment becomes a smart space, the control unit is connected to a server that manages resources or devices within the space (for example, a home server, an IPTV, and a set-top box). The agent unit 100 is a terminal which a user can carry anywhere, is connected to the control unit through a network, and serves to interact with a user.

Hereafter, although not described, the network according to the present invention may connect the control unit 10 and the agent unit 100 and be constructed using a wired Internet network of a TCP/IP protocol, a wireless Internet network of a WAP protocol, and a wired/wireless communication network.

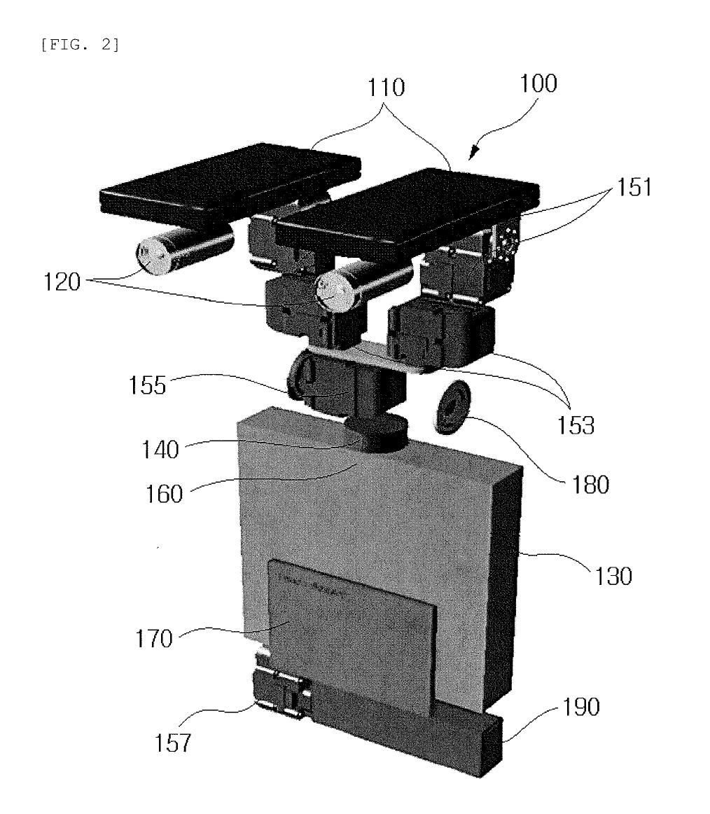

FIG. 2 is a diagram illustrating a portable computing device with intelligent robotic functions according to an exemplary embodiment of the present invention.

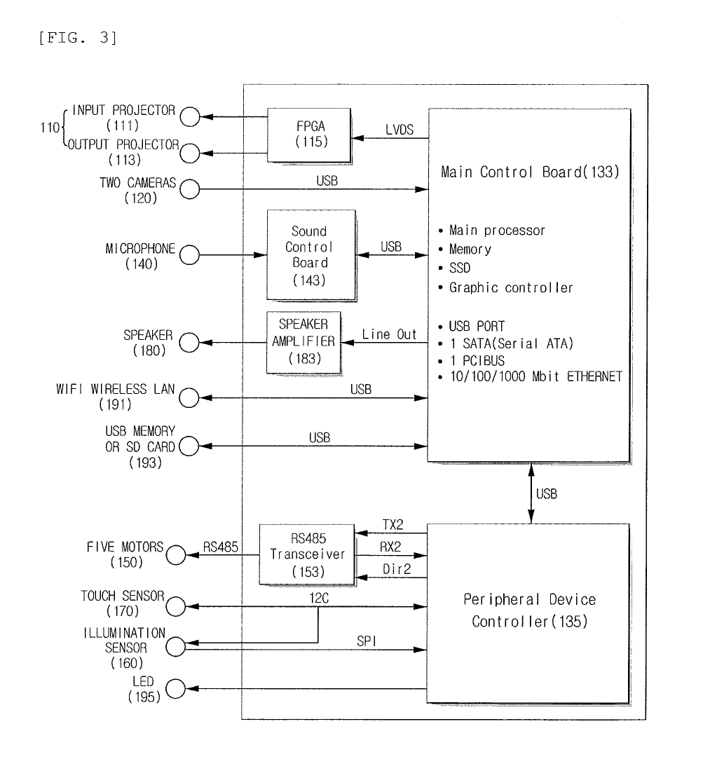

FIG. 3 is a block diagram illustrating a portable computing device with intelligent robotic functions according to an exemplary embodiment of the present invention.

Hereafter, a description is started with reference to FIGS. 2 and 3.

Referring to FIGS. 2 and 3, a portable computing device with intelligent robotic functions according to an exemplary embodiment of the present invention includes two projectors 110, a two cameras 120, a main board 130, a multi-channel microphone 140, a 5 motors 150, an illumination sensor 160, a touch pad 170, a stereo speaker 180, and a battery 190 as the agent unit.

The projector 110 provides a user interface screen and a service and contents screen and the user interface screen may be provided based on a graphic user interface (GUI) or adopt a stereoscopic 3D image using the image prewarping.

The projector 110 provides a user interface screen for user input and may be mounted with a camera 120 for capturing and recognizing a user behavior.

The projector 110 according to the exemplary embodiment of the present invention may be divided into an input projector 111 that provides a user interface screen for user input and an output projector 113 that outputs the generated contents.

The input projector 111 provides the user interface screen for user input and may be mounted with a camera for capturing and recognizing a user behavior on the user interface screen.

The output projector 113 may be mounted with a camera for recognizing and tracking a user behavior.

The projector 110 may be divided into input and output projectors 111 and 113, but input and output projectors may be integrally provided such that input/output screens may be integrally provided.

The projector 110 may be constituted by two pairs of projectors and cameras, and the cameras may be mounted at lower ends of the input and output projectors 111 and 113, respectively.

Specifically, referring to FIG. 2, two projectors divided into the input and output projectors 111 and 113 are provided and the cameras 120 are mounted at the lower ends of the projectors, respectively.

The positions of the cameras 120 are set to be mounted at the lower end of the projector 110, but may be changed such that the cameras 120 are provided at the side.

Interaction is performed by user commands using a finger gesture on a GUI screen output to the projector 110 and the camera 120 mounted at the lower end of the input projector 111 recognizes the output GUI screen and the finger gesture.

Here, when one pair of the input projector 111 and the camera 120 provides the GUI screen to the bottom surface, the output projector 113 of the other pair may provide a contents screen on the wall surface. The projector 110 may be set to transmit data by using a field programmable gate array (FPGA) 115, but is not limited thereto.

The camera 120 may be provided as an input device for detecting a finger gesture and used as an input device for recognizing a user, the user's location, and an ambient object according to circumstances.

The camera 120 may receive image information for ambient motion detection and face detection and recognition, fingertip detection, finger gesture recognition and object detection and recognition.

The image information according to the present exemplary embodiment is provided to recognize whether there is an ambient motion (motion detection), whether there is a human face (face detection), who he or she is (face recognition), at which position a user's finger is moved and with what gesture the finger is moved (finger tip detection and finger gesture recognition), and whether there is an object known to the portable computing device in front of the portable computing device (object detection and recognition).

The camera 120 may be detachably provided as a universal serial bus (USB) and may be modified in various ways.

The main board 130 connects and controls the projector 110 and the camera 120 and controls the network to communicate with the control unit connected through the network.

Here, the network is a remote object caller type of performing network communication between the agent unit and the control unit, that is, obtains a reference for a remote object from a client program and supports to call a function as if the object is a client's own object.

To this end, the network according to the present exemplary embodiment transmits a message by marshaling data to be transmitted in a standardized manner so as to be unaffected by a heterogeneous environment at a client side, obtains data by unmarshaling the transmitted message at a server side, activates and calls a remote object, and supports a series of operations of transmitting the result to the client side by the same method again.

The main board 130 may include a main control board 133 and a peripheral device controller 135 connecting peripheral devices such as various sensors, motors, and an LED.

The main control board 133 includes a processor, a memory, a hard disk, a graphic controller, a USB port, a communication modem, and a bus to perform a processing control function of the portable computing device with intelligent robotic functions.

The main board 130 may include a sound control board that performs voice processing for voice recognition, synthesis, and sound reproduction.

The main board 130 may perform all of the processings using a single main control board and be expanded by adding a control board.

Specifically, in the main board 130 according to the present exemplary embodiment, a function of a sound control board may be performed by a main control board and an image processing board may be separately provided.

The microphone 140 receives user information and user commands through a voice.

Sound information including the input voice is provided to recognize where the sound comes (sound source localization) and what he or she said (voice recognition).

The 5 motors 150 supply power for operating the projector 110, the camera 120, and a robotic computer body.

Specifically, the 5 motors 150 include vertical motion motors 151, horizontal motion motors 153, an entire rotational motion motor 155, and a leg rotary motor 157.

Here, the vertical motion motors 151 are provided at lower ends of the projectors 110 and the cameras 120 to supply vertical rotating power, the horizontal motion motors 153 are provided at lower ends of the vertical motion motors 151 to supply horizontal rotating power for the projectors 110 and the cameras 120, the entire rotational motion motor 155 is provided at lower ends of the horizontal motion motors 153 to supply entire rotating power for the projectors 110 and the cameras 120, and the leg rotary motor 157 is provided to supply power for autonomous operation of the agent unit.

The illumination sensor 160 senses external brightness to detect how bright or dark the surrounding environment is.

The touch sensor 170 is a device for inputting user commands through a touch and may recognize the user input command through information input from the touch sensor 170.

The stereo speaker 180 provides a voice to the outside and is connected to a speaker amplifier 183 that transmits a voice signal.

The battery 190 is provided to supply a power source for the agent unit.

The agent unit according to the present invention may further include a Wi-Fi wireless LAN 191 for wireless communication, a USB memory, an SD card 193, and an LED 195 that displays its own state according to circumstances.

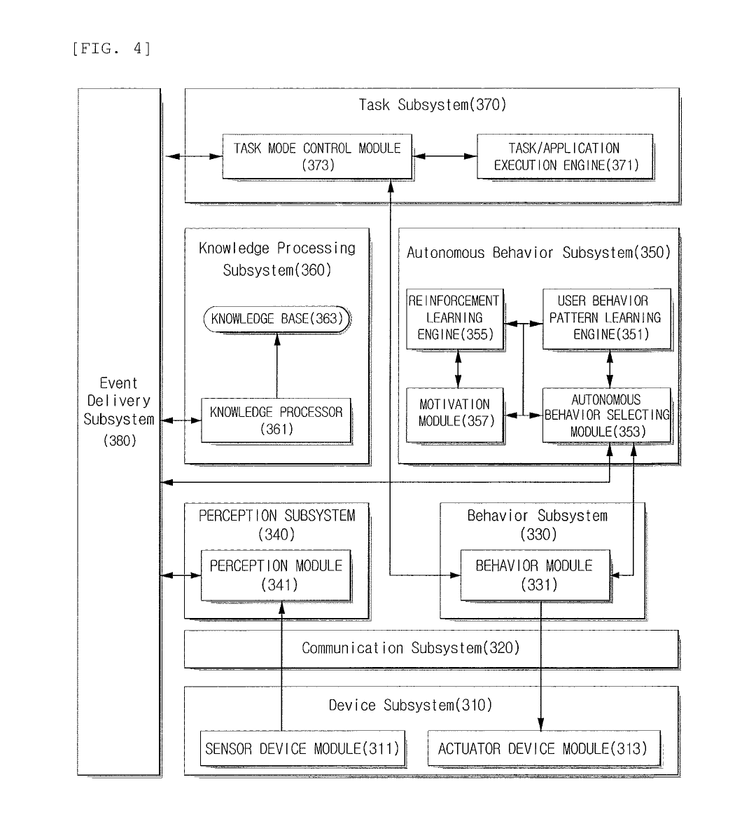

FIG. 4 is a diagram illustrating a software configuration of a portable computing device with intelligent robotic functions according to an exemplary embodiment of the present invention.

Hereafter, a software configuration of a robotic computer proposed in the present invention will be described with reference to FIG. 4.

In the present invention, the software includes a device subsystem 310, a communication subsystem 320, a perception subsystem 330, a knowledge processing subsystem 340, an autonomous behavior subsystem 350, a task subsystem 360, a behavior subsystem 370, and an event delivery subsystem 380.

The device subsystem 310 is installed at an agent unit side and includes device modules in which physical hardware devices including a sensor and an actuator of the agent unit are abstracted as software logic devices.

The device subsystem 310 according to the present exemplary embodiment acquires information from the physical device to transmit the information to perception subsystem modules or receives operation control information from the behavior subsystem to transmit the information to the physical device.

The device subsystem 310 includes a sensor device module 311 such as a camera, a microphone, a touch sensor, and an illumination sensor and an actuator device module 313 such as a projector, a stereo speaker, a motor, and an LED.

The communication subsystem 320 performs a communication framework function of a remote object call type that performs network communication between the agent unit and the control unit.

In other words, the communication subsystem 320 obtains a reference for a remote object from a client program and supports to call a function as if the corresponding object is a client's own object.

To this end, the communication subsystem 320 transmits a message by marshaling data to be transmitted in a standardized manner so as to be unaffected by a heterogeneous environment at a client side, obtains data by unmarshaling the transmitted message at a server side, activates and calls a remote object, and supports a series of operations of transmitting the result to the client side by the same method again.

The perception subsystem 330 includes a perception module 331 that perceives the current context on a user and an environment based on information transmitted from the device subsystem through a network.

In the present exemplary embodiment, the perception subsystem 330 recognize whether there is an ambient motion (motion detection), whether there is a human face (face detection), who he or she is (face recognition), at which position a user's finger is moved and with what gesture the finger is moved (finger tip detection and finger gesture recognition), and whether there is an object known to the portable computing device in front of the portable computing device (object detection and object recognition), based on image information transmitted from a camera sensor module.

In the present exemplary embodiment, the perception subsystem 330 recognizes where the sound comes (sound source localization) and what he or she said (voice recognition) from sound information of the multi-channel microphone. The perception subsystem 330 recognizes what command the user issues based on information from a contact sensor and recognizes how bright or dark the surrounding environment is through the illumination sensor.

In the connection relationship of the modules of the sensor devices, when an image is acquired, motion detection, object detection, and face detection are activated, and when a face is detected, an operation of recognizing the face is performed.

The knowledge processing subsystem 340 stores and manages information from the perception module as high-level knowledge of the user and the environment, serves to provide the knowledge when an application requests related information, and includes a knowledge base 343 and a knowledge processor 341.

The knowledge base 343 stores and manages basic information on the user, geometric information and semantic information on a space (a living room, a kitchen, and a bedroom), device and object information in an environment, and agent state-related information based on ontology and rules. The information is provided through the knowledge processor 341 at the query request of other system module or application for related information.

The autonomous behavior subsystem 350 serves to learn a behavior pattern in which a user uses a robotic computer and estimate a current state of the user to actively provide related applications and services in accordance with the current context, and includes a user behavior pattern learning engine 351, a motivation module 352, and an autonomous behavior selecting module 353.

The user behavior pattern learning engine 351 accumulates and learns information on who, when, where, and what he or she performed. The motivation module 352 processes a drive about when and what to do. The drive may include items such as a drive to talk to a person (social drive), a drive to take a rest (fatigue drive) and a drive to have a curiosity of novelty (curiosity drive).

When a task goal is set based on the estimated current situation of the user and its own motivation, the autonomous behavior selecting module 353 may select an appropriate task for attaining the goal.

A reinforcement learning engine 355 may learn feedback on whether the user accepts the autonomous behavior for the user positively or negatively and thus enable the robotic computer to gradually evolve through the long-term usage.

The task subsystem 360 is a module for controlling an operation of the entire system of a robotic computer and includes a task/application execution engine 361 and a task mode control module 363.

The robotic computer is controlled through the task mode control module 363 based on a state called a mode.

The mode may be divided into a system mode and an application mode. The system mode refers to a mode which is performed inside a system when there is no application execution by a user's request and the application mode may be defined as a work mode when actual application is executed.

The system mode may be redivided into a sleep mode, an idle mode, an observation mode, and an interaction mode.

When power of the robotic computer is on, the robotic computer enters the idle mode, which is a state where the robotic computer detects what change occurs in the environment. In the idle mode, motion detection by an image, sound source detection by sound, and a touch sensor are activated, such that the robotic computer detects what change occurs in the user or the environment.

The robotic computer enters a sleep mode when an operation time expires or the robotic computer is self-motivated to change to the sleep mode in the idle mode (A).

Meanwhile, when the robotic computer detects/recognizes a person around the robotic computer or is self-motivated to change to an autonomous behavior in the idle mode (B), the robotic computer enters an observation mode.

The observation mode refers to a state where the robotic computer continues to observe who and where he or she is. In the present exemplary embodiment, the robotic computer enters an interaction mode when a person calls the robotic computer or the robotic computer is self-motivated to want to talk to a person (C) in the observation mode.

The robotic computer enters the idle mode when the time expires or the robotic computer is self-motivated in the interaction mode (D).

In the meantime, in the interaction mode, the robotic computer receives and responds to a user command. When the user explicitly requests arbitrary application execution during the operation in the interaction mode or the robotic computer recommends application execution due to motivation for autonomous behavior and the user accepts the recommendation (E), the system mode is switched to a work mode. In this case, most of the resources of the system may be allocated to application.

Here, the robotic computer enters a sleep mode when the sleep mode is called or the robotic computer is self-motivated to change to autonomous behavior (F).

The robotic computer may enter the sleep mode when the sleep mode is called in the work mode (G).

Next, the robotic computer may enter an idle mode when touch input and activated motivation occur in the sleep mode.

The behavior subsystem 370 includes behavior modules 371 that serve to manage various unit behaviors of the robotic computer and perform a request of the system or application. The behavior includes a user tracking related behavior, an interaction related behavior, a projector/camera control related behavior, a media playback related behavior, and a state representation related behavior and a general developer may define and use a new behavior required for his or her application.

The event delivery subsystem 380 manages various events generated by physically distributed subsystems and functions to transfer information by exchanging messages among the system modules.

Particularly, the event delivery subsystem 380 distributes a sensing event transferred from the perception subsystem to the knowledge processing subsystem, the autonomous behavior subsystem, and the task subsystem, such that a context change may be recognized and a state model may be updated.

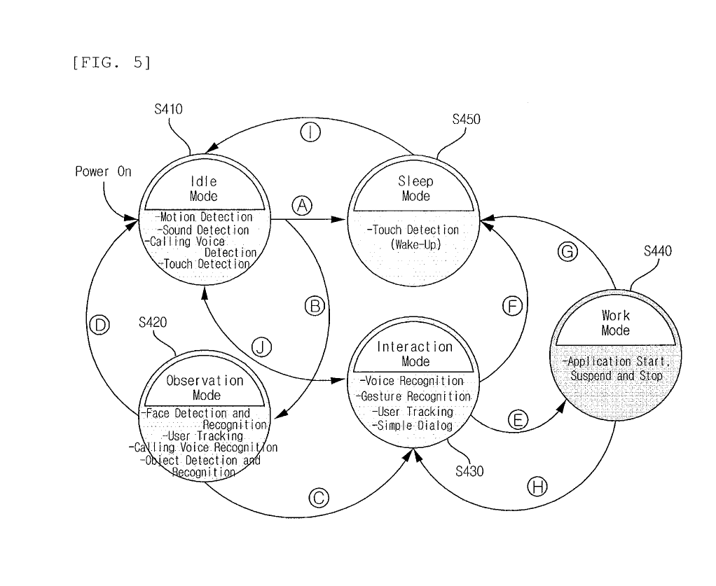

FIG. 5 is a view illustrating a control mechanism of a portable computing device with intelligent robotic functions according to an exemplary embodiment of the present invention.

Hereafter, an control mechanism of a portable computing device with intelligent robotic functions according to an exemplary embodiment of the present invention will be described with reference to FIG. 5.

FIG. 5 is a view illustrating an control mechanism of a portable computing device with intelligent robotic functions according to an exemplary embodiment of the present invention.

The portable computing device with intelligent robotic functions starts an idle mode step when system power is first turned on (S410). At step S410, it is detected what change occurs in the environment. Motion detection by an image, sound source detection by sound, and a touch sensor are activated, and thus, it is detected what change occurs in the user or the environment.

Next, at step S410, the portable computing device enters an observation mode when a person around the portable computing device is detected/recognized or the portable computing device is self-motivated to change to autonomous behavior (S420).

The observation mode of step S420 is a state where the portable computing device continues to observe who and where he or she is.

At step S420, the portable computing device enters an interaction mode when a person calls a robotic computer or the robotic computer is self-motivated to want to talk to the person (S430). In the interaction mode, the robotic computer receives and responds to a user command.

At step S430, the system mode of the portable computing device is switched to a work mode when the user explicitly requests arbitrary application execution or the portable computing device recommends application execution due to motivation for autonomous behavior and the user accepts the recommendation (S440). At step S440, the portable computing device assigns most of the resources of the system to an application.

Meanwhile, at step S410, the mode of the portable computing device is switched to a sleep mode when there is no change in the environment for a predetermined period of time or work stop is requested at step S440 (S450).

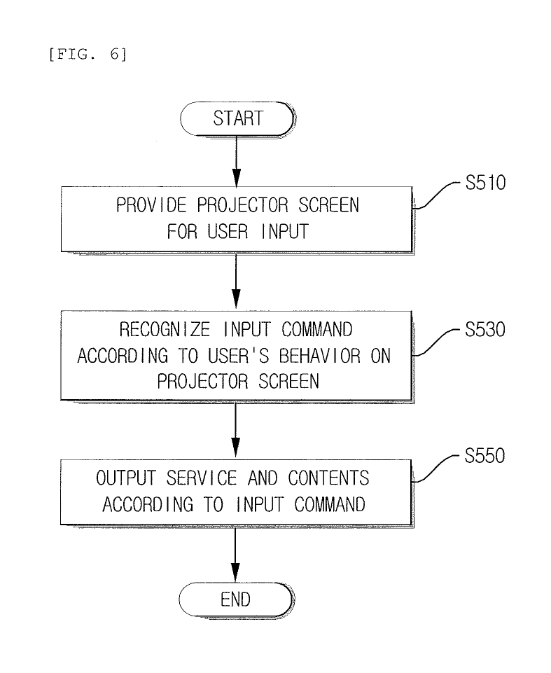

FIG. 6 is a processing flowchart for a portable computing device with intelligent robotic functions according to an exemplary embodiment of the present invention.

Hereafter, a method for operating a portable computing device with intelligent robotic functions will be described with reference to FIG. 6.

First, the portable computing device with intelligent robotic functions provides a projector screen for user input (S510).

After step S510, the portable computing device recognizes an input command according to a user behavior on the projector screen (S530).

At step S530, the portable computing device recognizes whether there is an ambient motion (motion detection), whether there is a human face (face detection), who he or she is (face recognition), at which position a user's finger is moved and with what gesture the finger is moved (finger tip detection and finger gesture recognition), and whether there is an object known to the portable computing device in front of the portable computing device (object detection and recognition), based on image information transmitted from a camera sensor module.

The portable computing device recognizes where the sound comes (sound source localization) and what the user said (voice recognition) based on sound information. The portable computing device recognizes what command the user issues based on information from a contact sensor and recognizes how bright or dark the surrounding environment is through the illumination sensor.

In the portable computing device, when an image is acquired, motion detection, object detection, and face detection are activated, and when a face is detected, an operation of recognizing the face is performed.

At step S530, after recognizing the input command according to the user behavior, the portable computing device outputs services and contents according to the input command (S550).

At step S530, the portable computing device may provide service and contents through object recognition as well as the explicit user's command.

For instance, when recognizing an object of a SPAM can, the portable computing device may output information on recommended cooking and recipe according thereto through a projector.

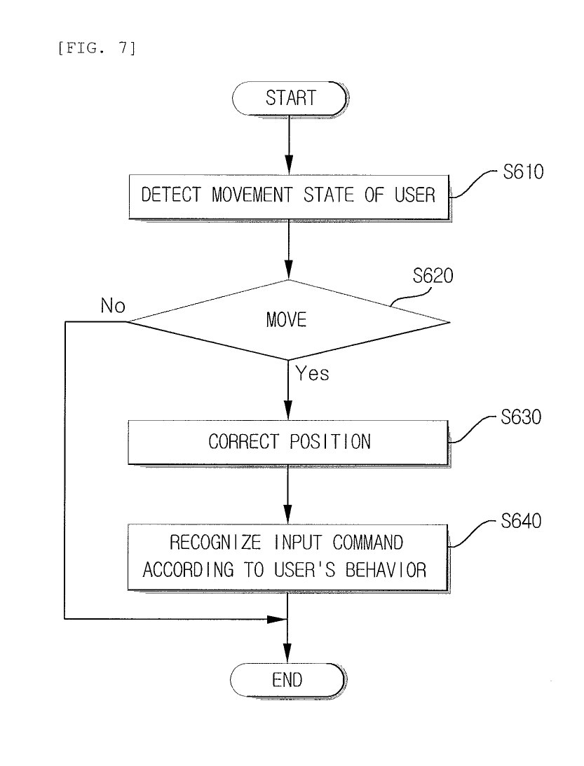

FIG. 7 is a processing flowchart for a position correction of a portable computing device with intelligent robotic functions according to an exemplary embodiment of the present invention in accordance with a user's movement.

Hereafter, a processing method for position correction according to the user's movement will be described with reference to FIG. V.

The portable computing device detects a movement state of a user (S610) and determines whether or not the user moves (S620).

At step S620, when the user moves, the portable computing device corrects a position so as to acquire an image (S630).

At step S630, the portable computing device acquires image information through position correction and recognizes input command according to a user behavior (S640).

According to the present invention, the portable computing device with intelligent robotic functions and the method for operating the same may be applied to a robotic computer that can interact with a surrounding environment to find a person, recognize a user, track the user, and talk with the user if necessary, and thus, may be applied to any robot technology field with artificial intelligence.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A portable computing device with intelligent robotic functions, comprising:
an input projector providing a user interface screen for user input and mounted with a camera for capturing and recognizing a user behavior on the user interface screen;
a main board recognizing a user command according to the user behavior and controlling to provide service and contents according to the user command; and
an output projector outputting the generated contents.

2. The portable computing device with intelligent robotic functions of claim 1, wherein the output projector is mounted with a camera for recognizing and tracking the user behavior.

3. The portable computing device with intelligent robotic functions of claim 1, wherein the main board recognizes a user command according to a finger gesture on the user interface screen and controls to provide the contents according to the user command.

4. The portable computing device with intelligent robotic functions of claim 1, wherein the main board receives image information from the camera and provides functions for ambient motion detection, face detection, face recognition, finger tip detection, finger gesture recognition and object detection and recognition.

5. The portable computing device with intelligent robotic functions of claim 1, further comprising:
a microphone receiving a user's voice, wherein the main board controls to recognize user information and a user command according to the user's voice.

6. The portable computing device with intelligent robotic functions of claim 1, wherein the main board transmits the user command to a control unit connected through a network and controls to receive contents according to the user command from the control unit.

7. The portable computing device with intelligent robotic functions of claim 1, further comprising:
vertical motion motors provided at lower ends of the projectors and the cameras to vertically rotate;
horizontal motion motors provided at lower ends of the vertical motion motors to horizontally rotate the projectors and the cameras; and
an entire rotary motor provided at lower ends of the horizontal motion motors to rotate the projectors and the cameras in their entirety.

8. The portable computing device with intelligent robotic functions of claim 1, wherein the cameras are mounted at lower ends of the projectors, respectively.

9. The portable computing device with intelligent robotic functions of claim 1, further comprising:
a knowledge base storing basic information on a user, geometric information and semantic information on a space, device and object information in an environment, and agent state-related information based on ontology,
wherein the main board controls to provide the information at the query request.

10. The portable computing device with intelligent robotic functions of claim 1, wherein the main board controls to learns a behavior pattern in which a user uses a robotic computer and estimate a current state of the user to actively provide related applications and services in accordance with the present state.

11. A portable computing device with intelligent robotic functions, comprising:
an input projector providing a user interface screen for user input and mounted with a camera capturing and recognizing a user behavior on the user interface screen;
a main board recognizing a user command according to the user behavior and controlling to receive service and contents according to the user command from a control unit connected through a network; and
an output projector outputting the generated contents.

12. The portable computing device with intelligent robotic functions of claim 11, wherein the main board recognizes a user command according to a finger gesture on the user interface screen and controls to receive service and contents according to the user command.

13. The portable computing device with intelligent robotic functions of claim 11, wherein the main board receives image information from the camera and provides functions for ambient motion detection, face detection, face recognition, finger tip detection, and object information and receive service and contents according to the user command from the control unit connected through the network.

14. A method for operating a portable computing device with intelligent robotic functions, comprising:
providing a user interface screen and a screen for outputting services and contents;
recognizing a user command according to a user behavior on the user interface screen; and
outputting service and contents according to the user command.

15. The method of claim 14, further comprising:
recognizing and tracking the user behavior.

16. The method of claim 14, further comprising:
detecting a movement state of the user; and
correcting a position according to the movement of the user.

17. The method of claim 14, further comprising:
receiving image information from the camera to provide functions for ambient motion detection, face detection, face recognition, finger tip detection, and object information.

18. The method of claim 14, further comprising:
recognizing user information and user command according to a user's voice.

19. The method of claim 14, further comprising:
transmitting the user command to a server connected through a network and receiving the service and contents according to the user command from the server.

20. The method of claim 14, further comprising:
storing basic information on a user, geometric information and semantic information on a space, device and object information in an environment, and agent state-related information based on ontology and rules; and
providing the information at the query request.

21. The method of claim 14, further comprising:
learning a behavior pattern in which a user uses a robotic computer and estimating a current state of the user to actively provide related applications and services in accordance with the current state.
